(19) United States
(12) Patent Application Publication
(10) Pub. No.: US 2017/0221337 A1
(43) Pub. Date: Aug. 3, 2017

(54) System and Method for Handling Emergency Warning Alerts

(71) Applicant: Wipro Limited, Bangalore (IN)

(72) Inventors: Tinku Malayil JOSE, Bangalore (IN); Manish VERMA, Bangalore (IN)

(73) Assignee: Wipro Limited

(21) Appl. No.: 15/071,618

(22) Filed: Mar. 16, 2016

(30) Foreign Application Priority Data
Feb. 2, 2016 (IN) 201641003604

(51) Int. Cl. G08B 21/10; G08B 25/10

(52) U.S. Cl. CPC G08B 21/10; G08B 25/10

(57) ABSTRACT

Method and system of handling emergency warning alerts is disclosed. The method comprises the steps of receiving, by a first emergency gateway, at least one emergency alert message. The method further comprises, retrieving, by the first emergency gateway, presence information of a user in response to receiving the at least one emergency alert message. The method further comprises, identifying by the first emergency gateway, at least one emergency alarm device based on the presence information of the user. The method further comprises, transmitting by the first emergency gateway, the at least one emergency alert message to the at least one emergency alarm device.

### TECHNICAL FIELD

This disclosure relates generally to the field of emergency warning systems, and more specifically a method and a system of handling emergency warning alerts.

### BACKGROUND

Traditionally, emergency alert warning systems used to be considered as dumb terminals as an alarm is generated either manually or based on some input signal in case of an emergency. Recently, technology has evolved over time with respect to emergency warning systems. Consumers are nowadays using smartphones and/or other mobile computing devices to respond to or deal with the emergencies, or to be warned about them The emergency warning systems are making use of internet and smart devices connected to it for generating an alarm or an alert to alert users about impending disasters, so that they can take precautions.

In one conventional approach, there are dedicated emergency warning systems. The dedicated emergency warning systems receive warning/alert messages from external service providers and government agencies and in turn transmit these messages to different smart devices to warn the users. However, the dedicated emergency warning systems may not be transmit the warning messages accurately as users may not always be interacting or be in the proximity of a particular or dedicated smart device, and thus the user may not be properly warned. Further, each dedicated emergency system, works independently, and hence if one receives an emergency alert message from the external agencies, the conventional emergency warning systems may not be able to send the messages to other smart devices, or to alert the user.

### SUMMARY

In one embodiment, a method of handling emergency warning alerts is disclosed. The method comprises receiving, by a first emergency gateway, at least one emergency alert message. The method further comprises retrieving, by the first emergency gateway, presence information of a user in response to receiving the at least one emergency alert message. The method further comprises identifying by the first emergency gateway, at least one emergency alarm device based on the presence information of the user. The method further comprises transmitting by the first emergency gateway, the at least one emergency alert message to the at least one emergency alarm device.

In another embodiment, a system for handling emergency warning alerts is disclosed. The system includes at least one processor and at least one memory device. The at least one memory device stores instructions that, when executed by the at least one processor, causes the at least one processor to perform operations comprising receiving, at least one emergency alert message. The operation further comprises retrieving, presence information of a user in response to receiving the at least one emergency alert message. The operation further comprises, identifying at least one emergency alarm device based on the presence information of the user. The operation further comprises, transmitting the at least one emergency alert message to the at least one emergency alarm device.

In another embodiment, a non-transitory computer readable medium, including instructions stored thereon is disclosed. These instructions, when processed by at least one processor, causes the at least one processor to perform operations comprising receiving, at least one emergency alert message. The operation further comprises retrieving presence information of a user in response to receiving the at least one emergency alert message. The operation further comprises, identifying at least one emergency alarm device based on the presence information of the user. The operation further comprises, transmitting the at least one emergency alert message to the at least one emergency alarm device.

It is to be understood that both the foregoing general description and the following detailed description are exemplary and explanatory only and are not restrictive of the Invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary network implementation for handling emergency warning alerts, in accordance with some embodiments of the present subject matter.

FIG. 2 illustrates an emergency gateway system for handling emergency warning alerts, in accordance with some embodiments of the present subject matter.

FIG. 3 illustrates an exemplary method for handling emergency warning alerts, in accordance with some embodiments of the present subject matter.

FIG. 4 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

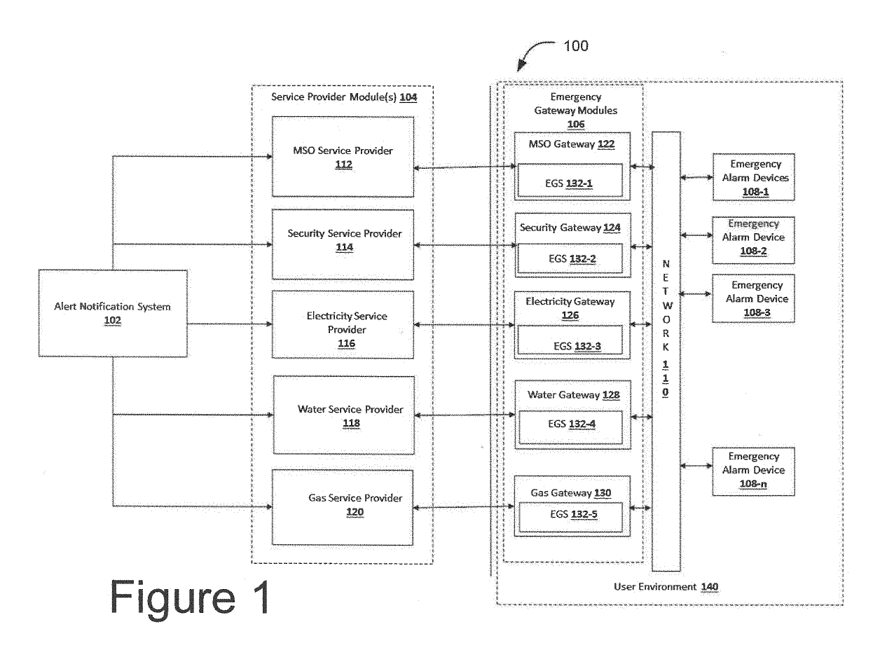

FIG. 1 illustrates an exemplary network implementation 100 for handling emergency warning alerts, in accordance with some embodiments of the present subject matter.

As shown in FIG. 1, the network implementation 100 includes an alert notification system 102, service provider module(s) 104, and a user environment 140. In case of an emergency situation, the alert notification system 102 may send emergency alert messages to various entities, such as users, service providers, organizations. Examples, of the emergency situations may include, but not limited to flood, tsunami, typhoon, riot, fire, theft, and extreme weather conditions. The alert notification systems are typically operated by government agencies authorized to issue and transmit emergency alert messages. For example, in case of an earthquake, these government agencies may send the emergency alert messages through the emergency notification system 102.

The service provider module(s) 104 may include one or more modules managed by service providers, who provide utilities, such as broadband, cable TV, security, gas, electricity. In an example, the service providers may be a multi system operator (MSO) service provider 112, a security service provider 114, an electricity service Provider 116, a water service provider 118, and a gas service provider 120. It may be noted that although FIG. 1 illustrates five different service providers, it may be apparent to a person skilled in the art that the service provide modules may include other service providers as well without deviating from the scope of the invention.

As shown in FIG. 1, the user environment 140 may include emergency gateway modules 106 communicating with various emergency alarm devices 108-1, 108-2, 108-3 . . . , and 108-N through a network 110. Hereinafter, the various emergency alarm devices 108-1, 108-2, 108-3 . . . , and 108-N may be collectively referred to as emergency alarm devices 108 and Individually referred to as an emergency alarm device 108. In an example, the user environment 140 may be understood as a smart home premise, of a user, comprising one or more smart devices communicatively coupled to each other. The emergency alarm devices 108 may comprise of user devices and utility control devices. The user devices are the smart devices, connected to the network as described in the network implementation 100, in FIG. 1 at the consumer home premises, that have processing power, or that can send and receive signals. Examples of such smart devices may include television sets, mobile phones, refrigerators, smart sensors, smart toilets, smart mirrors, video cameras etc. The utility control devices are those devices, connected to the network as described in the network implementation 100, in FIG. 1 at the consumer home premises, which can control the supply of utilities like gas, electricity, water, etc. or broadcast of different services like media, security services etc.

Further, the emergency gateway modules 106 includes various emergency gateway devices, such as a MSO Gateway 122, a Security Gateway 124, an Electricity Gateway 126, a Water Gateway 128, and a Gas Gateway 130. In an example, the emergency gateway modules 106 receives the emergency alert messages from the service provider modules 104. It may be noted the emergency gateways as shown in FIG. 1 are exemplary and there may be other emergence gateways also corresponding to different service providers.

As shown in FIG. 1, each of the emergency gateways comprises an emergency gateway system 132-1, 132-2 . . . 132-N. The MSO Gateway 122 comprises ESG 130-1, the Security Gateway 124 comprises ESG 130-2, the Electricity Gateway comprises ESG 130-3, the Water Gateway comprises ESG 130-4 and the Gas Gateway comprises ESG 130-5. Hereinafter, the emergency gateway system 132-1, 132-2 . . . 132-N may be individually referred to as the emergency gateway system 132. In an example, even though the ESGs are shown to be present in the emergency gateways, it may be noted that the ESGs may be present external to the emergency gateways.

The emergency gateway systems are responsible for sending and receiving messages to/from the smart devices in the emergency alert system through the network 110, to send/receive the message. The emergency gateway systems may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The network 110 may include, without limitation, a direct interconnection, local area network (LAN), wide area network (WAN), wireless network (e.g., using Wireless Application Protocol), the Internet, etc. Using the network 110, the emergency gateway devices may communicate with the smart device. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the emergency gateway devices may itself embody one or more of these devices.

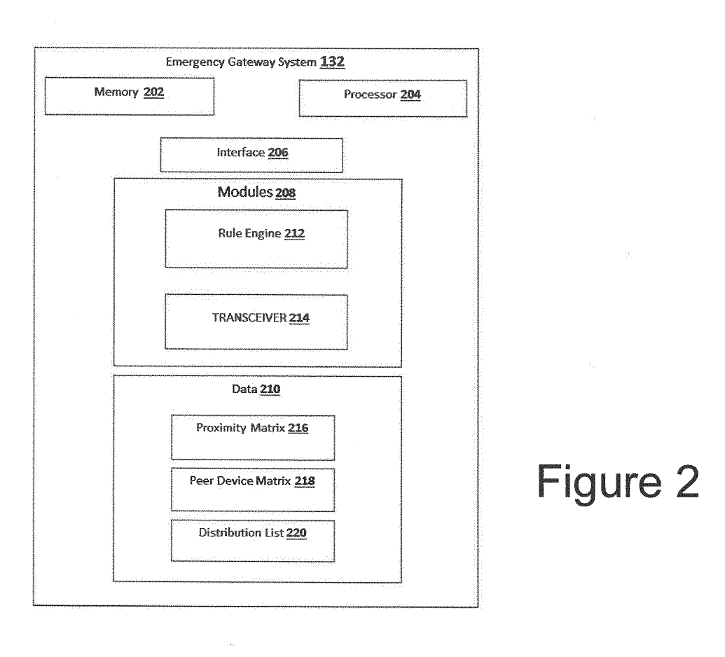

The emergency gateway system for handling emergency alert messages is explained in more detail in conjunction with FIG. 2. As shown in FIG. 2, the emergency gateway system 132, comprises of a processor 204, a memory 202 coupled to the processor 204, and interface(s) 206. For brevity, the emergency gateway system 132 may be referred to as system 132 hereinafter. The processor 204 may be implemented as one or more microprocessors, microcomputers, microcontrollers, digital signal processors, central processing units, state machines, logic circuitries, and/or any devices that manipulate signals based on operational instructions. Among other capabilities, the processor 204 is configured to fetch and execute computer-readable instructions stored in the memory 202. The memory 202 can include any non-transitory computer-readable medium known in the art including, for example, volatile memory (e.g., RAM), and/or non-volatile memory (e.g., EPROM, flash memory, etc.).

The interface(s) 206 may include a variety of software and hardware interfaces, for example, a web interface, a graphical user interface, etc., allowing the system 132 to interact with user devices. Further, the interface(s) 206 may enable the system 132 respectively to communicate with other computing devices. The interface(s) 206 can facilitate multiple communications within a wide variety of networks and protocol types, including wired networks, for example LAN, cable, etc., and wireless networks such as WLAN, cellular, or satellite. The interface(s) 206 may include one or more ports for connecting a number of devices to each other or to another server.

In one example, the system 132 includes modules 208 and data 210. In one embodiment, the modules 208 and the data 210 may be stored within the memory 206. In one example, the modules 208, amongst other things, include routines, programs, objects, components, and data structures, which perform particular tasks or implement particular abstract data types. The modules 208 and may also be implemented as, signal processor(s), state machine(s), logic circuitries, and/or any other device or component that manipulate signals based on operational instructions. Further, the modules 208 can be implemented by one or more hardware components, by computer-readable instructions executed by a processing unit, or by a combination thereof.

In one implementation, the modules 208 further include a rule engine 212, and a transceiver 214. In an example, the modules 208 may also comprise other modules (not shown in FIG. 1). The other modules may perform various miscellaneous functionalities of the system 132. It will be appreciated that such aforementioned modules may be represented as a single module or a combination of different modules.

In one example, the data 210 serves, amongst other things, as a repository for storing data fetched, processed, received and generated by one or more of the modules 208. In one implementation, the data 210 may include a proximity matrix 216, a peer device matrix 218, and a distribution list 220. In one embodiment, the data 210 may be stored in the memory 202 in the form of various data structures. Additionally, the aforementioned data 210 can be organized using data models, such as relational or hierarchical data models. In an example, the data 210 may also comprises other data used to store data, including temporary data and temporary files, generated by the modules 208 for performing the various functions of the system 132.

In operations, in case of an emergency to send the emergency alert messages to various devices, the transceiver 214 may receive the emergency alert message from various service providers. The transceiver may be understood as a device that comprises a transmitter circuit and a receiver circuit. However, it will be apparent to a person skilled in the art, that separate transmitters and receivers may also be used in conjunction with the system 132, without deviating from the scope of the Invention.

The emergency alert message may include information related to service categorization, genre and impact mapping. In an example, the service categorization of an emergency alert message, may include sorting of the messages on the basis of category of service provider, like utility service provider in electricity, water, gas, security, media services etc. In an example, the categorizing emergency alert messages on the basis of genre includes, whether the alert is for flood, tsunami, typhoon, riot, fire, theft etc. The sorting and categorization of the emergency alert messages are generally done by the service providers or the alert notification system which may be operated by the government, and the required information is put within the emergency alert message. In an example, the impact mapping information may be calculated based on the extent of damage that can be caused by the emergency. Further, factors, such as the genre and geographic location of the emergency may be taken into account to calculate impact of the emergency. In an example, a first emergency gateway, may receive an emergency alert message from at least one utility service provider responsible for providing services, such as MSO, security, electricity, and water, gas. The emergency alert messages are generally received by the service providers from the alert notification system 102 operated by the government agencies/natural disaster units.

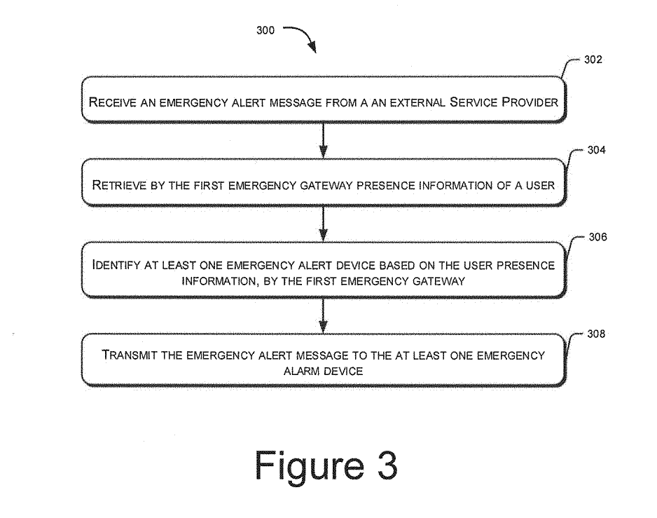

Upon receiving the emergency alert message, the rule engine 212, may then retrieve user presence information from the proximity matrix 216. The proximity matrix 216, maintains a list of the user devices, which are in proximity to a user, or which can detect the presence of user. The proximity information is determined based on the user presence information received by the first emergency gateway, and the plurality of second emergency gateways from the at least one emergency alarm device. The retrieval of the user presence information by the first emergency gateway as per step 304 of FIG. 3, takes place from the proximity matrix. The transceiver 214 receives the user presence information from the at least one emergency alarm device. Presence information of the user, may be detected, using a video camera, an audio (Microphone array), passive infrared sensors (PIR), pressure sensors, radiofrequency tags, fingerprint readers, motion sensors, etc. which are integrated in objects commonly found and configured with the network implementation 100.

In another example, the rule engine 212 may identify the at least one emergency alarm device on the basis of the user presence information.

The rule engine 212, dynamically generates a distribution list, which comprises of the at least one user device in a particular zone determined by the user presence information sent by the at least one emergency alarm device, and the at least one utility control devices in the network implementation as per FIG. 1, controlling different utilities, like gas, electricity, weather, security, etc., based on the impact of the emergency on the utilities. For example, if the Emergency Alert Message is because of fire, then not only the user has to be alerted and fire alarm should go off in the various user devices, but also the gas valve has to be closed down and electricity has to be switched off, or other precautionary measures have to be taken. Hence in this situation, the distribution list will consist of utility control devices dedicated to particular services that is fire, gas and electricity on which there will be sufficient impact because of the particular alert and the at least one user devices that are configured to a particular zone. In an example, the network implementation within the consumer premises may be divided into different zones, and the at least one emergency alarm device is categorized into one or more of the zones. Examples of the zones may be bedroom, hall, kitchen etc. These zones are defined and demarcated at the system initialization and configuration stage FIG. 5. The at least one emergency alarm device associated with particular zones can keep changing dynamically, because of modifications to the network implementation 100, within the consumer home premises. The user presence information also contains zone information, and information about the corresponding emergency alarm devices configured to the particular zone.

Further, the rule engine 212, with the help of the transceiver 214, transmits the emergency alert message, to the at least one emergency alarm device based on the user presence information and the emergency alarm device being present in the distribution list.

In another example, the rule engine 212, with the help of the transceiver 214, may transmit the emergency alert message to the at least one emergency alarm device associated with a particular zone. On the basis of the received emergency alert message, the at least one user device, associated with a particular zone, will alert the user, and the at least one utility control device will take necessary actions, like tuming off the particular utility, or just setting off an alarm to alert the user, present in the zone. Hence all the emergency alarm devices associated with the particular zone present in the distribution list will receive the emergency alert message.

In yet another example, the rule engine 212, with the help of the transceiver 214, may transmit the at least one emergency alert message, to the at least one emergency alarm device, based on at least one of service categorization, a genre and an impact mapping information as explained before. The at least one emergency alert message contains at least one of service categorization, a genre and an impact mapping information, and the emergency alarm devices associated with each of

Further in an example, the transceiver 214, may transmit the emergency alert message to all the other emergency gateway systems, connected to the network, as described in the network implementation 100 in FIG. 1, so that precautionary measures may be taken based on the emergency alert message. Precautionary measures may include but not limited to switching off of the particular service by alerting the at least one utility control device, or transmitting emergency alert messages to the at least one user device, where the emergency alert message needs to be sent, being present in the distribution list, but could not be sent by the first emergency for some issue.

In yet another example, the emergency alert message may be transmitted to all the emergency alarm devices in the distribution list, by the rule engine 212, with the help of the transceiver 214.

FIG. 3 illustrates a method for handling emergency alert messages, in accordance with some embodiments of the present subject matter.

The method 300 may be described in the general context of computer executable instructions. Generally, computer executable instructions can include routines, programs, objects, components, data structures, procedures, modules, and functions, which perform particular functions or implement particular abstract data types. The method 300 may also be practiced in a distributed computing environment where functions are performed by remote processing devices that are linked through a communication network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternative methods. Additionally, individual blocks may be deleted from the method 300 without departing from the spirit and scope of the subject matter described herein. Furthermore, the method 200 can be implemented in any suitable hardware, software, firmware, or combination thereof.

With reference to FIG. 2, at block 302, an emergency alert message is received from an external service provider. In an example, the emergency alert message comprises a service categorization, a genre and an impact mapping data. Service categorization of an emergency alert message, may include sorting of the messages on the basis of category of service provider, like utility service provider in electricity, water, gas, security, media services etc. Categorizing emergency alert messages on the basis of genre includes, whether the alert is for flood, tsunami, typhoon, riot, fire, theft etc. Sorting and categorization of the emergency alert messages are done by the Service providers or the alert notification system which may be operated by the government, and the required information is put within the emergency alert message. Impact mapping information is calculated based on the extent of damage that can be caused by the emergency. Factors like the genre and geographic location of the emergency are taken into account to calculate impact of the emergency. In an example, a first emergency gateway, may receive an emergency alert message from at least one utility service provider who may be responsible for providing services like MSO, security, electricity, water, gas etc. This message is further received by the service providers from the alert notification system which may be operated by the government.

At block 304, presence information of the user is retrieved by the first emergency gateway in response to receiving the at least one emergency alert message. In an example, the first emergency gateway and the plurality of second emergency gateways receives user presence information from the at least one emergency alarm device. Presence information of the user, may be detected, using a video camera, audio (Microphone array), passive infrared sensors (PIR), pressure sensors, radiofrequency tags, fingerprint readers, motion sensors, etc. which are integrated in objects commonly found and configured with the emergency alarm devices, or the network as described in the network implementation 100, in FIG. 1 at the consumer home premises. The first Emergency Gateway and the plurality of second emergency gateways, maintains a peer matrix, which consists of all the emergency alarm devices connected to the network as described in the network implementation 100, in FIG. 1 at the consumer home premises, and which can send and receive data. The first Emergency Gateway and the plurality of second emergency gateways, also maintains a proximity matrix, which maintains a list of the user devices, which are in proximity to a user, or which can detect the presence of user. The proximity information is determined based on the user presence information received by the first emergency gateway, and the plurality of second emergency gateways from the at least one emergency alarm device. The retrieval of the user presence information by the first emergency gateway as per step 203 takes place from the proximity matrix. The proximity matrix and the peer device matrix, can be stored in a database in a memory module.

At block 306, at least one emergency alarm device is identified based on the presence information, as received and stored in the proximity matrix.

The network as described in the network implementation 100, in FIG. 1 at the consumer home premises, is divided into different zones, and the at least one emergency alarm device is categorized into one or more of the zones. Examples of the zones may be bedroom, hall, kitchen etc. These zones are defined and demarcated at the system initialization and configuration stage FIG. 5. The at least one emergency alarm device associated with particular zones can keep changing dynamically, because of modifications to the network as described in the network implementation 100, in FIG. 1 at the consumer home premises. The user presence information sent by the at least one emergency alarm device to the first emergency gateway and the plurality of second emergency gateways, also contains zone information, and information about the corresponding emergency alarm devices configured to the particular zone.

At 307, the first emergency gateway, transmits the at least one emergency alert message to the at least one emergency alarm device based on the user presence information. Necessary actions may be taken by the emergency alarm device as per the type of emergency. It may include warning the user of the emergency, as well as controlling the supply of the utility.

In an example, the first emergency gateway and the plurality of second emergency gateways, dynamically generate a distribution list, which comprises of the at least one user device in a particular zone determined by the user presence information sent by the at least one emergency alarm device, and the at least one utility control devices in the network as described in the network implementation 100, in FIG. 1 at the consumer home premises, controlling different utilities, like gas, electricity, weather, security, etc., based on the impact of the emergency on the utilities. For example, if the Emergency Alert Message is because of fire, then not only the user has to be alerted and fire alarm should go off in the various user devices, but also the gas valve has to be closed down and electricity has to be switched off, or other precautionary measures have to be taken. Hence in this situation, the distribution list will consist of utility control devices dedicated to particular services that is fire, gas and electricity on which there will be sufficient impact because of the particular alert and the at least one user devices that are configured to a particular zone.

In another example, the first emergency gateway, may transmit the emergency alert message to the at least one emergency alarm device associated with a particular zone. On the basis of the received emergency alert message, the at least one user device, associated with a particular zone, will alert the user, and the at least one utility control device associated with a particular zone will take necessary actions, like turning off the particular utility, or just setting off an alarm to alert the user, present in the zone.

In yet another example, the first emergency gateway may transmit the at least one emergency alert message, to the at least one emergency alarm device, based on at least one of service categorization, a genre and an impact mapping information. The at least one emergency alert message contains at least one of service categorization, a genre and an impact mapping information

Further in an example, the first emergency gateway, may transmit the emergency alert message to all the other emergency gateways connected to the network as described in the network implementation 100, in FIG. 1 at the consumer home premises, so that precautionary measures may be taken based on the emergency alert message. Precautionary measures may include but not limited to switching off of the particular service by alerting the at least one utility control device, or transmitting emergency alert messages to the at least one user device, where the emergency alert message needs to be sent, being present in the distribution list, but could not be sent by the first emergency for some issue.

Additional illustrative embodiments are listed below. In one embodiment, the first emergency gateway and the plurality of second emergency alert gateways, may validate the authenticity, duplication and error in the emergency alert message received. The first emergency gateway and the plurality of second emergency alert gateways may check whether the same emergency alert message had been previously received, and whether required action had been taken, and if proper action had been taken, then the emergency alert message is ignored. The first emergency gateway and the plurality of second emergency alert gateways also may check if the emergency alert message was received from a particular emergency alarm device, then it will transmit the message to other emergency alarm devices in the distribution list. Hence the distribution list comprises of all the devices where the emergency alert messages have to be sent on a priority.

In another embodiment, the emergency messages may be changed into some form electrical signal, to activate non-smart alarms, or dumb terminals, connected directly to emergency gateways. Dumb terminals or non-smart alarms are devices, which do not have any processing power, but have input and output capabilities. Hence if there is an electrical signal the non-smart alarms may go off or on.

In another embodiment, when one emergency gateway receives an emergency alert message, then there may be a situation, where it may not be able to send it to all or any of the user devices on the distribution list, because of some network problem. However it can be sent to the plurality of second gateways, who also contain the peer matrix and the proximity matrix, and the receiving gateway can then create a distribution list and transmit the messages to the at least one emergency alarm device present in the distribution list.

In another embodiment, the categorization of the at least one emergency alarm device based on the zones defined as a part of system configuration and initialization, may change, by changing or moving the emergency alarm devices or changing the layout of the network as described in the network implementation 100, in FIG. 1 at the consumer home premises. The categorization of the devices changes dynamically and the emergency alarm devices list associated with each zone, gets updated after every change of zone by a particular device.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

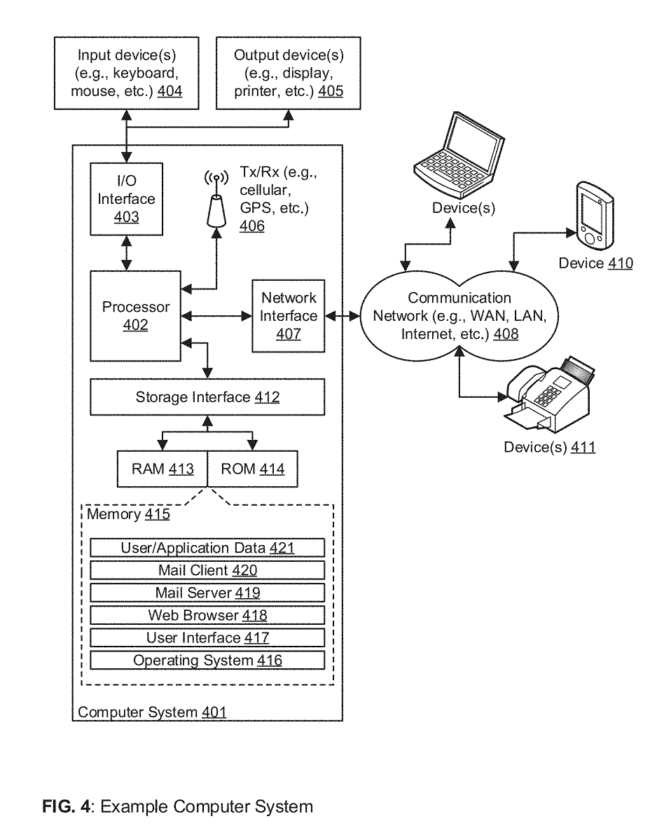

FIG. 4. is a block diagram of an exemplary computer system for implementing embodiments consistent with the present disclosure. Variations of computer system 401 may be used for implementing Emergency Gateway System. Computer system 401 may comprise a central processing unit (“CPU” or “processor”) 402. Processor 402 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network Error! Reference source not found.08, the computer system 401 may communicate with devices 410, 411, and 412. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system Error! Reference source not found.01 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, Icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. (e.g., Proximity matrix 216, Peer Device Matrix 218 and 220) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described system and method for handling emergency warning alerts. The Illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A method of handling emergency warning alerts, the method comprising:
receiving, by a first emergency gateway, at least one emergency alert message;
retrieving, by the first emergency gateway, presence information of a user in response to receiving the at least one emergency alert message, wherein the presence information indicate presence of the user, and wherein the emergency alert message comprises a service categorization, a genre, and impact mapping data;
generating dynamically, by the first emergency gateway, a distribution list comprising a plurality of emergency alarm devices based on the presence information, the service categorization, the genre and the impact mapping data; and
transmitting, by the first emergency gateway, the at least one emergency alert message to the at least one emergency alarm device in the generated distribution list.

2. The method of claim 1, wherein the at least one emergency alarm device comprises, at least one user device and at least one utility control device.

3. The method of claim 1, further comprising categorizing the at least one emergency alarm device into one or more zones.

4. The method of claim 3, further comprising transmitting the at least one emergency alert message to the at least one emergency alarm device in the one or more zones.

5-6. (canceled)

7. The method of claim 1, further comprising transmitting, by the first emergency gateway, the at least one emergency alert message to a plurality of second emergency gateways.

8. The method of claim 1, further comprising taking one or more actions by the first emergency gateway based on the at least one emergency alert message.

9. The method of claim 1, further comprising, receiving by the first emergency gateway presence information of the user from the at least one emergency alarm device.

10. An emergency gateway system for handling emergency warning alerts, the system comprising:
at least one processor; and
at least one memory device storing instructions that, when executed by the at least one processor, cause the at least one processor to perform operations comprising:
receiving, at least one emergency alert message;
retrieving, presence information of a user in response to receiving the at least one emergency alert message, wherein the presence information indicates presence of the user, and wherein the emergency alert message comprises a service categorization, a genre and impact mapping data;
generating dynamically, a distribution list comprising a plurality of emergency alarm devices based on the presence information, the service categorization, the genre and the impact mapping data; and
transmitting, the at least one emergency alert message to the at least one emergency alarm device in the generated distribution list.

11. The system of claim 10, wherein the at least one emergency alarm device comprises, at least one user device and at least one utility control device.

12. The system of claim 10, further comprising categorizing the at least one emergency alarm device into one or more zones.

13. The system of claim 10, further comprising transmitting the at least one emergency alert message to the at least one emergency alarm device in the one or more zones.

14-15. (canceled)

16. The system of claim 10, further comprising transmitting, by the first emergency gateway, the at least one emergency alert message to a plurality of second emergency gateways.

17. The system of claim 10, further comprising taking one or more actions by the first emergency gateway based on the at least one emergency alert message.

18. The system of claim 10, further comprising, receiving by the first emergency gateway presence information of the user from the at least one emergency alarm device.

19. A non-transitory computer readable medium including instructions stored thereon that when processed by at least one processor causes an emergency gateway system to perform operations comprising:
receiving, at least one emergency alert message;
retrieving, presence of information a user in response to receiving the at least one emergency alert message, wherein the presence information indicates presence of the user, and wherein the emergency alert message comprises a service categorization, a genre and impact mapping data;
generating dynamically, a distribution list comprising a plurality of emergency alarm devices based on the presence information, the service categorization, the genre and the impact mapping data; and
transmitting, the at least one emergency alert message to the at least one emergency alarm device in the generated distribution list.

20. (canceled)

21. The method of claim 1, further comprising determining the impact mapping data based on the genre, geographic location of an emergency and an extent of damage that can be caused by the emergency.

22. The method of claim 1, wherein the service categorization comprises sorting of the emergency alert messages based on category of service provider, and wherein the genre comprises at least one of flood, tsunami, typhoon, riot, fire or theft.
